(19) United States
(12) Patent Application Publication
(10) Pub. No.: US 2007/0178789 A1
(43) Pub. Date: Aug. 2, 2007

(54) Fiber mat and process making same

(75) Inventors: Linlin Xing, Wayne, NJ (US); William Bittle, York, SC (US); Yaron Steinhauer, Valley Cottage, NY (US)

Correspondence Address: Att: William J. Davis, Esq.;GAF MATERIALS CORPORATION, Legal Department, Building No. 8, 1361 Alps Road, Wayne, NJ, 07470, US

(73) Assignee: BUILDING MATERIALS INVESTMENT CORPORATION

(21) Appl. No.: 11/345,136

(22) Filed: Feb. 1, 2006

(51) Int. Cl. B32B 27/04; B32B 17/02

(52) U.S. Cl. 442/180; 428/297.4; 162/152; 162/156; 162/164.1; 162/165; 162/218; 162/231

(57) ABSTRACT

A fiber mat of improved wet web strength and a process of making same is disclosed. The fiber mat comprises: fibers; a resinous fiber binder; and a binder modifier comprising a hydrophobically modified acrylic swellable emulsion.

### FIELD OF THE INVENTION

Embodiments of the present invention relate to a fiber mat and process of making same.

### BACKGROUND OF THE INVENTION

High strength fiber mats have become increasingly popular in the building materials industry. Most commonly used in roofing shingles, fiber mats have numerous other material applications, including use in roofing, siding and floor underlayment; insulation facers; floor and ceiling tile; and vehicle parts.

Various fiber mats and methods of making same have been previously described. For example, U.S. Pat. Nos. 4,135,029; 4,258,098; 5,914,365; and 6,642,299 describe glass fiber mats made by a wet-laid process. Glass fiber mats made by the wet-laid process are formed from glass fibers held together by a binder material. The last two patents relate to improved wet web strength with styrene-maleic anhydride copolymer (SMA), styrene-acrylate copolymers, and mixtures thereof.

Typically, in wet processed glass fiber mats, the binder is applied in a liquid form and dispersed onto the glass fibers by a curtain type applicator. Conventional wet processes strive to produce a uniform coating of binder on the glass fibers. After the binder and glass fibers have been dried and cured, the glass fiber mat is cut as desired.

A major problem in the manufacturing process and use of some known fiber mats is inadequate wet web strength. The wet web strength of wet glass mat has significant impact on runnability of glass mat production and mat properties. In order to prevent mat web from breaking during production, the production line speed has to be reduced due to a lower wet web strength of wet glass mat before curing. Also, a lower wet web strength requires a higher vacuum drawing to support the wet web and minimize web breaking. But the higher vacuum drawing will lead to undesired mat property, such as a high mat tensile ratio.

Inadequate shingle tear and tensile strengths also can reduce the ability of the finished roofing product to resist stresses during service on the roof. Because building materials, generally, and roofing shingles, in particular, are often subjected to a variety of weather conditions, the fiber mats should also maintain their strength characteristics under a wide range of conditions.

### SUMMARY OF THE INVENTION

Responsive to the foregoing challenges, Applicant has developed an innovative fiber mat for use in a building material, the mat comprising: a plurality of fibers; a resinous fiber binder coating the fibers; and a binder modifier comprising from about 0.05 wt. % to about 20 wt. %, based on the weight of the binder, the binder modifier comprising a hydrophobically modified acrylic swellable emulsion.

Applicant has further developed an innovative fiber mat for use in a building material, comprising: a plurality of glass fibers; and a fixative composition comprising a fiber binder and between about 0.05 wt. % and about 20 wt. %, based on the weight of the binder, and a binder modifier comprising a hydrophobically modified acrylic swellable emulsion.

Applicant has developed an innovative process of making a fiber mat for use in a building material, the process comprising the steps of: (a) forming an aqueous fiber slurry; (b) removing water from the fiber slurry to form a wet fiber mat; (c) saturating the wet fiber mat with an aqueous solution of a fiber binder; (d) spraying the wet fiber mat with a binder modifier comprising a hydrophobically modified acrylic swellable emulsion, and (d) drying and curing the wet fiber mat to form a fiber mat product. In one embodiment, the fiber binder and the binder modifier may be mixed together and applied in a single step.

It is to be understood that both the foregoing general description and the following detailed description are exemplary and explanatory only, and are not restrictive of the invention as claimed.

### DETAILED DESCRIPTION OF EMBODIMENTS OF THE INVENTION

The fiber mat of the present invention may comprise a plurality of fibers coated or impregnated with a fixative composition. The fixative composition may comprise a resinous fiber binder, and a binder modifier comprising between about 0.05 wt. % and about 20.0 wt. % of a hydrophobically modified acrylic swellable emulsion, based on the fiber binder weight.

In all embodiments of the present invention the hydrophobically modified acrylic swellable emulsion ALCOGUM® SL-78 having a molecular weight of 14,000 or similar emulsions. ALCOGUM® SL-78 is produced by Alco Chemicals in Tennessee, and is an acrylate-based emulsion copolymer supplied at 30% active solids in water. Other hydrophobically modified acrylic swellable emulsions include: SL-117, molecular weight 200,000; SL-120, molecular weight 60,000; and SL-70, molecular weight 30,000.

In one embodiment, the modifier may further comprise a secondary binder modifier. The secondary binder modifier may comprise, for example, polyurethane, styrenebutadiene, and/or acrylic polymers. The secondary binder modifier may be incorporated with the binder modifier as a composition, or may be added separately. In one embodiment of the present invention, the secondary binder modifier may comprise less than about 15 wt. %, based on the total weight of the binder solids.

The fiber binder may comprise between about 5 wt. % and about 30 wt.%, based on the fiber mat product weight. In one embodiment of the present invention, the fiber binder may comprise a formaldehyde type resin. The fiber binder may include, but is not limited to, a urea/formaldehyde resin, a phenol/formaldehyde resin, a melamine/formaldehyde resin, and/or a mixture thereof. It is contemplated, however, that other binders, such as, for example, ethylene vinyl acetate, and other known resins adapted for binding mat fibers may be used without departing from the scope and spirit of the present invention.

In one embodiment of the present invention, the urea-formaldehyde resin is a commercially available material, such as, for example, GP2997 supplied by Georgia Pacific Resins, Inc.; Dynea 246 from Dynea Co.; and Borden FG 486D from Borden Chemical Inc. Other commercial formaldehyde resins may include PR-913-23, supplied by Borden Chemical, Inc. As will be apparent to those of ordinary skill in the art, other commercially or non-commercially available binders may be used without departing from the scope and spirit of the present invention.

The resinous fiber binder may contain methylol groups which, upon curing, form methylene or ether linkages. These methylols may include, for example, N,N′-dimethylol; dihydroxymethylolethylene; N,N′-bis (methoxymethyl), N,N′-dimethylol-propylene; 5,5-dimethyl-N, N′-dimethylolpropylene; N, N′-dimethylolethylene; N, N′-dimethylolethylene and the like.

The fiber binder and the binder modifier are adapted to be compatible. The components may be intimately admixed in an aqueous medium to form a stable emulsion which may not become overly gummy, or gel, even after storage for periods of 24 hours or longer. This may be advantageous in practical commercial use of the composition. It is contemplated that individual aqueous mixtures for binder and modifier may be used in embodiments of the present invention.

In one embodiment of the present invention, the fibers comprise glass fibers. The glass fibers may comprise individual fiber filaments having an average length in the range of, but not limited to, from about 1/4 inch to about 3 inches, and an average diameter in the range of, but not limited to, from about 5 to about 50 micrometers (μm). It is contemplated, however, that the glass fibers may be in another form, such as, for example, a continuous strand or strands. In an alternative embodiment of the present invention, the fibers may comprise other fibers, including, but not limited to, wood, polyethylene, polyester, nylon, polyacrylonitrile, and/or a mixture of glass and one or more other fibers. In one embodiment, the fiber mat may further comprise a small amount of filler, e.g. less than about 0.5%, based on the fiber weight. A fiber mixture may be optional for construction material application, such as, for example, roofing and siding, because excessive amounts of filler may reduce porosity and vapor ventability of the fiber mat.

In the finished cured mat product, the fiber content may be in the range of from about 55 wt. % to about 98 wt. %. In one embodiment of the present invention, the fiber content is more particularly in the range of from about 66 wt. % and about 88 wt. %. The binder modifier content may be in the range of from about 0.05 wt. % to about 45 wt. %. In one embodiment of the present invention, the binder modifier content is more particularly in the range of from about 15 wt. % to about 30 wt. %.

In one embodiment of the present invention, the fibers may be formed into a mat with the aid of a dispersing agent. The fiber dispersing agent may comprise, for example,.tertiary amine oxides (e.g. jN-hexadecyl-N,N-dimethyl amine oxide), bis(2-hydroxyethyl) tallow amine oxide, dimethyl hydrogenated tallow amine oxide, dimethylstearyl amine oxide and the like, and/or mixtures thereof. As will be apparent to those of ordinary skill in the art, other known dispersing agents may be used without departing from the scope and spirit of the present invention. The dispersing agent may comprise a concentration in the range of from about 10 ppm to about 8,000 ppm, based on the amount of fiber. The dispersing agent may further comprise a concentration in the range of from about 200 ppm to about 1,000 ppm, based on the amount of fiber.

In one embodiment, the fibers may be formed into a mat with the aid of one or more viscosity modifiers. The viscosity modifier may be adapted to increase the viscosity of the composition such that the settling time of the fibers is reduced and the fibers may be adequately dispersed. The viscosity modifier may include, but is not limited to, hydroxyl ethyl cellulose (HEC), polyacrylamide (PM), and the like. As will be apparent to those of ordinary skill in the art, other viscosity modifiers may be used without departing from the scope and spirit of the present invention.

The process of making a fiber mat in accordance with one embodiment of the present invention will now be described. The process will be described with particular reference to a wet-laid process. It is contemplated, however, that other processes known in the art, such as, for example, a dry-laid process, may be used without departing from the scope and spirit of the present invention. Furthermore, the process is described using chopped bundles of glass fibers. As discussed above, however, other types of fiber content are considered well within the scope of the present invention.

The process of forming glass fiber mats according to one embodiment of the present invention comprises adding chopped bundles of glass fibers of suitable length and diameter to an aqueous medium to form an aqueous fiber slurry. As discussed above, the aqueous medium may include a suitable dispersing agent. A viscosity modifier or other process aid may also be added to the water/dispersing agent medium. From about 0.05 to about 0.5 wt. % viscosity modifier in white water may be suitably added to the dispersant to form the slurry.

The glass fibers may be sized or unsized, and may be wet or dry, as long as they are capable of being suitably dispersed in the water/dispersing agent medium. The fiber slurry, containing from about 0.03 wt. % to about 8 wt. % solids, is then agitated to form a workable dispersion at a suitable and uniform consistency. The fiber slurry may be additionally diluted with water to a lower fiber concentration to between about 0.02 wt. % and about 0.08 wt. %. and about 0.08 wt. %. In one embodiment, the fiber concentration may be more particularly diluted to about 0.04 wt. % fiber. The fiber slurry is then passed to a mat-forming machine such as a wire screen or fabric for drainage of excess water. The excess water may be removed with the assistance of vacuum.

The fibers of the slurry are deposited on the wire screen and drained to form a fiber mat. The fiber mat may then be saturated with an aqueous solution of binder. The aqueous binder solution may comprise, for example, from about 10 wt. % to about 40 wt. % solids. The fiber mat may be soaked for a period of time sufficient to provide the desired fixative for the fibers. Excess aqueous binder solution may then be removed, preferably under vacuum.

The formed fiber mat may then be sprayed with the binder modifier, such as a hydrophobically modified swellable emulsion, to achieve the desired concentration. An aqueous solution of the modifier may be used to obtain a uniform distribution over the binder treated fibers. In one embodiment of the present invention, either before or after applying the binder modifier, the fiber mat may be compressed, for example by passing it between rollers or another compressing device, to reduce mat thickness for curing. In addition to spraying, this invention also contemplates neutralizing the acid with a base such as ammonia and adding it into binder solution to avoid gelling. It is believed that the ammonia will volatize at high curing temperature and the acid form will return.

After treatment with binder or binder/modifier composition, if desired, the mat is then dried and the fixative composition may be cured in an oven at an elevated temperature. A temperature in the range of about 160° C. to about 400° C., for at least about 2 to about 10 seconds, may be used for curing. In one embodiment, a cure temperature in the range of about 225° C. to about 350° C. may be used. It is contemplated that in an alternative embodiment of the present invention, catalytic curing may be provided with an acid catalyst, such as, for example, ammonium chloride, p-toluene sulfonic acid, or any other suitable catalyst.

The combination of the hydrophobically modified swellable emulsion and binder used in various embodiments of the present invention may provide several advantages over current binder compositions. For example, the tensile strength of the shingle may be increased. In addition, the tensile strength of the shingle may be increased at lower temperatures to minimize cracking and failure. Other advantages will be apparent to one of ordinary skill in the art from the above detailed description and/or from the practice of the invention.

Having generally described various embodiments of the present invention, reference is now made to the following examples which illustrate embodiments of the present invention and comparisons to a control sample. The following examples serve to illustrate, but are not to be construed as limiting to, the scope of the invention as set forth in the appended claims.

### Preparation of Glass Mat and Lab Shingle—Example

Part A. In a 20 liter vessel at room temperature, under constant agitation, 5.16 g of chopped bundles of glass fibers, having an average 20-40 mm length and 12-20 micron diameter, were dispersed in 12 liters of water containing 800 ppm of N-hexadecyl-N,N-dimethylamine oxide to produce a uniform aqueous slurry of 0.04 wt. % fibers. The fiber slurry was then passed onto a wire mesh support with dewatering fabric, and a vacuum was applied to remove excess water and to obtain a wet mat containing about 60% fibers.

Part B. Aqueous samples of 24 wt. % solids containing urea/formaldehyde resin binder (UF) and ALCOGUM® SL-78 as binder modifier were separately prepared and applied to individual samples of wet glass mats prepared by the procedure in Part A. The individual wet glass mats were soaked in the binder/modifier solutions under ambient conditions after which excess solution was removed under vacuum to provide binder/modifier wet mats containing 38 wt. % glass fibers, 12 wt. % binder/modifier and 50 wt. % water.

Part C. For comparison purposes, Control samples were prepared as described in Parts A and B except that the UF binder was used alone or with OmnovaGenflo3112 latex, i.e. a carboxylated styrene-butadiene copolymer latex.

Part D. Wet web strength of the above uncured wet mats was measured in the following way. The uncured wet mat was laid over a sheet of plastic with a hole in the center. Then weights were continuously added to the center of the mat to elongate the uncured mat to a defined distance. The final weight was recorded as the wet web strength of the uncured mat.

Part E. The mat samples made according to Parts A and B were dried and cured for 8 to 9 seconds at 270° C. to 300° C. to obtain dry glass mats weighing about 92 g/m₂ and having a Loss on Ignition (LOI) of about 24%.

Part F. Each of the above cured mat samples were passed to a two-roller coating machine where a 30 mil layer of 32 wt. % asphalt and 68 wt. % limestone filler at 420° F. was applied to each side of the mats. After cooling, the thus-filled asphalt coated mates were tested for shingle tear and shingle tensile properties. The results of these tests are given in the Tables below.

### Tables

Compositions

| | | | Invention | Invention |
|---|---|---|---|---|
| Ingredient | Control-1 | Control-2 | Example-1 | Example-2 |
| UF Binder | FG486D | FG486D | FG486D | FG486D |
| Binder | None | Omnova | AlcogumSL-78 | AlcogumSL- |
| Modifier | | Genflo3112 | | 78 |
| Modifier | None | Carboxylated | Hydrophobically | Hydrophobic- |
| Chemistry | | Styrene | Modified Acrylic | ally |
| | | Butadiene | Swellable | Modified |
| | | Copolymer | Emulsion | Acrylic |
| | | | | Swellable |
| | | | | Emulsion |
| UF: | 100 | 99/1 | 99/1 | 99.5/0.5 |
| Modifier | | | | |
| (w/w) | | | | |

Mat and Shingle Properties

| | | | | | Invention |
|---|---|---|---|---|---|
| | | | | Invention | Example |
| | | | | Example vs. | vs. |
| | | | | Control-1 | Control-2 |
| | | | Invention | (% | (% |
| Property | Control-1 | Control-2 | Example-1 | increase) | increase) |
| Wet Web | 89 | 131 | 268 | 201% | 105% |
| Strength | | | | | |
| (gf) | | | | | |
| Mat Tear | 1041 | 822 | 1057 | 1% | 59% |
| (gf) | | | | | |
| Shingle | Not | 1704 | 2068 | Not | 21% |
| Tear | Available | | | Available | |
| (gf) | | | | | |
| Shingle | 1076 | 1037 | 1207 | 12% | 16% |
| Tensile | | | | | |
| (psi) | | | | | |

Mat and Shingle Properties

| | | | | | Invention |
|---|---|---|---|---|---|
| | | | | Invention | Example |
| | | | | Example vs. | vs. |
| | | | | Control-1 | Control-2 |
| | | | Invention | (% | (% |
| Property | Control-1 | Control-2 | Example-2 | increase) | increase) |
| Wet Web | 89 | 131 | 189 | 112% | 44% |
| Strength | | | | | |
| (gf) | | | | | |
| Mat Tear | 1041 | 822 | 1190 | 14% | 45% |
| (gf) | | | | | |
| Shingle | 1076 | 1037 | 1276 | 19% | 23% |
| Tensile | | | | | |
| (psi) | | | | | |

The results show a significant increase in the wet web strength, mat tear strength, shingle tear and shingle tensile strength for the invention Examples over Control-1 and Control-2 samples.

It will be apparent to those skilled in the art that various other modifications and variations can be made in the construction, configuration, and/or operation of the present invention without departing from the scope or spirit of the invention. Embodiments of the fiber mat may be used in the building material including but not limited to, shingles, underlayment, insulation facers, floor and ceiling tile, vehicle parts, and/or any other suitable building material. Thus, it is intended that that present invention cover all such modifications and variations of the invention, provided they come within the scope of the appended claims and their equivalents.

What is claimed is:

1. A fiber mat for use in a building material, said mat comprising:
a plurality of fibers;
a resinous fiber binder coating said fibers; and
a binder modifier comprising a hydrophobically modified acrylic swellable emulsion.

2. The fiber mat of claim 1, wherein said resinous fiber binder comprises a formaldehyde type binder.

3. The fiber mat of claim 2, wherein said formaldehyde type binder is selected from the group consisting of: a urea/formaldehyde binder, a phenol/formaldehyde binder, and a melamine/formaldehyde binder.

4. The fiber mat of claim 1, wherein the concentration of said fibers in said mat is between about 55 wt. % and about 98 wt. %.

5. The fiber mat of claim 1, wherein said fibers comprise glass fibers.

6. The fiber mat of claim 1, wherein the binder further contains an acid selected from the group consisting of maleic acid or citric acid.

7. The fiber mat of claim 1, wherein the binder further contains an acid selected from the group consisting of: formic acid, acetic acid, propionic acid, benzoic acid, butyric acid, acrylic acid, lactic acid, glycolic acid, malic acid, all amino acids, oxalic acid, malonic acid, succinic acid, glutaric acid, adipic acid, or salicylic acid.

8. The fiber mat of claim 7, wherein said formaldehyde type binder is selected from the group consisting of: a urea/formaldehyde binder, a phenol/formaldehyde binder, and a melamine/formaldehyde binder.

9. The fiber mat of claim 6, wherein the concentration of said fibers in said mat is between about 55 wt. % and about 98 wt. %.

10. The fiber mat of claim 6, wherein said fibers comprise glass fibers.

11. The fiber mat of claim 1 further comprising a secondary binder modifier selected from the group of polyurethane, styrenebutadiene, and acrylic polymers.

12. A fiber mat for use in a building material, comprising:
a plurality of glass fibers; and
a fixative composition comprising a fiber binder and between about 0.05 wt.% and about 20 wt.% binder modifier, based on the weight of the binder, wherein the binder modifier comprises a hydrophobically modified acrylic swellable emulsion.

13. The fiber mat of claim 12, wherein the concentration of the fiber binder, based on the weight of the fibrous mat, is in the range of from about 5 wt. % and about 30 wt. %.

14. The. fiber mat of claim 12, wherein said glass fibers comprise a plurality of glass filaments having an average length of from about 0.25 to about 3 inches and a diameter of from about 5 to about 50 micrometers.

15. The fiber mat of claim 14, wherein the concentration of said glass filaments is between about 55 and about 98 wt. %.

16. The fiber mat of claim 12, wherein said fiber binder comprises a formaldehyde type binder selected from the group consisting of: a urea/formaldehyde binder, a phenol/formaldehyde binder, and a melamine/formaldehyde binder.

17. The fiber mat of claim 12, wherein the hydrophobically modified acrylic swellable emulsion contains maleic acid or citric acid.

18. The fiber mat of claim 17, wherein the concentration of the fiber binder, based on the weight of the fibrous mat, is in the range of from about 5 wt. % and about 30 wt. %.

19. The fiber mat of claim 17, wherein said glass fibers comprise a plurality of glass filaments having an average length of from about 0.25 to about 3 inches and a diameter of from about 5 to about 50 micrometers.

20. The fiber mat of claim 17, wherein the concentration of said glass filaments is between about 55 and about 98 wt. %.

21. The fiber mat of claim 17, wherein said fiber binder comprises a formaldehyde type binder selected from the group consisting of: a urea/formaldehyde binder, a phenol/formaldehyde binder, and a melamine/formaldehyde binder.

22. The fiber mat of claim 12, wherein the binder further contains an acid selected from the group consisting of: maleic acid, citric acid, formic acid, acetic acid, propionic acid, benzoic acid, butyric acid, acrylic acid, lactic acid, glycolic acid, malic acid, all amino acids, oxalic acid, malonic acid, succinic acid, glutaric acid, adipic acid, and salicylic acid.

23. The fiber mat of claim 12 further comprising of a secondary binder modifier selected from the group of polyurethane, styrenebutadiene, and acrylic polymers.

24. A process of making a fiber mat for use in a building material, said process comprising the steps of:
(a) forming an aqueous fiber slurry;
(b) removing water from the fiber slurry to form a wet fiber mat;
(c) saturating the wet fiber mat with an aqueous solution of a fiber binder;
(d) spraying the wet fiber mat with a binder modifier comprising an acrylic binder modifier, and
(e) drying and curing the wet fiber mat to form a fiber mat product.

25. The process of claim 24, wherein the aqueous fiber slurry further comprises a fiber dispersing agent.

26. The process of claim 24, wherein the binder modifier contains maleic acid or citric acid.

27. The process of claim 24, wherein the binder further contains an acid selected from the group consisting of: maleic acid, citric acid, formic acid, acetic acid, propionic acid, benzoic acid, butyric acid, acrylic acid, lactic acid, glycolic acid, malic acid, all amino acids, oxalic acid, malonic acid, succinic acid, glutaric acid, adipic acid, and salicylic acid.

28. The process of claim 24, wherein the aqueous fiber slurry further comprises a fiber dispersing agent.

29. The process of claim of claim 24, wherein the binder modifier further comprises a secondary binder modifier selected from the group of polyurethane, styrenebutadiene, and acrylic polymers.

30. A fiber mat for use in a building material, said fiber mat comprising:
55 wt. % to 98 wt. % of fibers;
5 wt. % to 30 wt. % of a fiber binder comprising a urea/formaldehyde binder, a phenol formaldehyde binder, or a melamine/formaldehyde binder; and
0.05-20 wt. % of a hydrophobically modified acrylic swellable emulsion of 14,000 molecular weight.
